(19) United States
(12) Patent Application Publication
(10) Pub. No.: US 2017/0083881 A1
(43) Pub. Date: Mar. 23, 2017

(54) SYSTEM AND METHOD FOR AUTOMATICALLY RANKING PAYMENT PROMISES

(71) Applicant: INTERNATIONAL BUSINESS MACHINES CORPORATION, ARMONK, NY (US)

(72) Inventors: SILVIA CRISTINA SARDELA BIANCHI, SAO PAULO (BR); VICTOR FERNANDES CAVALCANTE, CAMPINAS (SP) (BR); MAIRA ATHANAZIO DE CERQUEIRA GATTI, RIO DE JANEIRO (BR); PAULO MARQUES CALDEIRA JUNIOR, CAMPINAS (BR)

(21) Appl. No.: 14/856,993

(22) Filed: Sep. 17, 2015

(51) Int. Cl. G06Q 20/10; G06Q 50/00

(52) U.S. Cl. CPC G06Q 20/102; G06Q 50/01

(57) ABSTRACT

A method of managing digital promises includes receiving transaction information and a request for a digital promise ranking. The transaction information includes identifying information of a first party and/or a second party. Each digital promise belongs to the first party and has a corresponding owner. A relationship score is calculated between the corresponding owner of each digital promise and the second party. An affinity score is calculated between the corresponding owner of each digital promise and the second party. A reputation score is calculated for the owner of each digital promise. A final score of each digital promise is calculated based on the relationship score, the affinity score and the reputation score. The digital promise rank is generated based on the final score of each digital promise.

### BACKGROUND

Exemplary embodiments of the present invention relate to ranking payment promises. More particularly, exemplary embodiments of the present invention relate to a system and method for automatic rank payment promises based on social relationship affinity.

Generally, unbanked and underbanked populations may have limited financial service portfolios and limited credit profiles. Unbanked and underbanked populations may rely on informal financial practices or informal credit, such as lending among friends and neighbors. One practice is to sell goods in exchange for a promise to pay at a later date, which may be referred to as on ‘I Owe You’ (IOU). For example, a merchant may provide goods or services to a client and record the purchase in a purchase log for later payment. The merchant may wait for a customer to return on the later date to pay for the previously received goods or services. The merchant may use money received for previously provided goods or services to purchase additional goods for sale to other customers. However, if a merchant wishes to purchase goods or services prior to receiving payment the merchant may request a loan from a bank, which may result in interest being paid to the bank. It may be desirable to analyze the risk of providing goods or services in exchange for a promise to pay at a later date to unbanked and underbanked populations. However, such unbanked and underbanked populations may have limited or no credit or transaction history data for analyzing the risk of providing goods or services to such populations. New credit analysis tools may be desirable to evaluate the value of IOU's provided by unbanked and underbanked populations.

### SUMMARY

Exemplary embodiments of the present invention provide a method of managing digital promises including receiving transaction information and a request for a digital promise ranking. The transaction information includes identifying information of a first party and/or identifying information of a second party. The digital promises are retrieved from an electronic database. Each digital promise belongs to the first party and has a corresponding owner. A relationship score is calculated between the corresponding owner of each digital promise and the second party. The relationship score indicates a degree of relationship between the corresponding owner of each digital promise and the second party. An affinity score is calculated between the corresponding owner of each digital promise and the second party. The affinity score indicates a level of similarity between the corresponding owner of each digital promise and the second party. A reputation score is calculated for the owner of each digital promise. A final score of each digital promise is calculated based on the relationship score, the affinity score and the reputation score. The digital promise rank is generated based on the final score of each digital promise.

According to an exemplary embodiment of the present invention the digital promise having the highest final score may be selected. The digital promise having the highest final score may be transferred from the first party to the second party in exchange for goods or services from the second party.

According to an exemplary embodiment of the present invention the digital promise ranking may be output to a display of a user device of the first party to facilitate selection of one of the digital promises in the digital promise ranking by the first party.

According to an exemplary embodiment of the present invention a set of preferences defined by at least one of the owners of the digital promises and the second party may be received. One of the digital promises may be selected based on the digital promise ranking and the set of preferences. The selected digital promise may be transferred from the first party to the second party in exchange for goods or services from the second party

According to an exemplary embodiment of the present invention at least one preference of the set of preferences may be defined as rules including a Boolean expression.

According to an exemplary embodiment of the present invention the relationship score may be calculated based on at least one of a role assigned to the owners of the digital promises or the second party, a relationship status between the owners of the digital promises and the second party, a social distance between the owners of the digital promises and the second party, and a number of past interactions occurring between the owners of the digital promises and the second party.

According to an exemplary embodiment of the present invention at least one of the role, the relationship status, the social distance, and the number of past interactions may be determined using information retrieved from at least one social network.

According to an exemplary embodiment of the present invention the affinity score may be calculated based on at least one of previous transaction behavior of the owners of the digital promises and the second party, personal preferences of the owners of the digital promises and the second party, goals of the owners of the digital promises and the second party, and a degree of financial similarity of the owners of the digital promises and the second party.

According to an exemplary embodiment of the present invention at least one of the previous transaction behavior, the personal preferences, the goals, and the degree of financial similarity may be determined using information retrieved from at least one social network.

According to an exemplary embodiment of the present invention the reputation score of the corresponding owner of each digital promise may reflect the corresponding owner's reputation during a predefined time interval.

According to an exemplary embodiment of the present invention the reputation score of the corresponding owner of each digital promise may be based on the corresponding owner's average repayment time relating to repaying previous digital promises.

According to an exemplary embodiment of the present invention a weight may be assigned to each of the relationship score, the affinity score, and the reputation score. The final score may be adjusted based on the weights. Values of the weights may be selected by one of the first party and the second party.

Exemplary embodiments of the present invention provide a computer system configured to manage digital promises. The computer system includes a memory storing a computer program and a processor configured to execute the computer program. The computer program is configured to perform the following steps. Receive transaction information and a request for a digital promise ranking from a first party. The transaction information includes identifying information of the first party and identifying information of a second party. Retrieve the digital promises from an electronic database. Each digital promise belongs to the first party and has a corresponding owner. Calculate a relationship score between the corresponding owner of each digital promise and the second party. The relationship score indicates a degree of relationship between the corresponding owner of each digital promise and the second party. Calculate an affinity score between the corresponding owner of each digital promise and the second party. The affinity score indicates a level of similarity between the corresponding owner of each digital promise and the second party. Calculate a reputation score of the owner of each digital promise. Calculate a final score of each digital promise based on the relationship score, the affinity score and the reputation score. Generate the digital promise ranking based on the final score of each digital promise.

According to an exemplary embodiment of the present invention the computer program may be configured to select, automatically, the digital promise having the highest final score, and electronically transfer the digital promise having the highest final score from the first party to the second party in exchange for goods or services from the second party.

According to an exemplary embodiment of the present invention the computer program may be configured to output the digital promise ranking to a display of a user device of the first party to facilitate selection of one of the digital promises in the digital promise ranking by the first party.

According to an exemplary embodiment of the present invention the relationship score may be calculated based on at least one of a role assigned to the owners of the digital promises or the second party, a relationship status between the owners of the digital promises and the second party, a social distance between the owners of the digital promises and the second party, and a number of past interactions occurring between the owners of the digital promises and the second party. The affinity score may be calculated based on at least one of previous transaction behavior of the owners of the digital promises and the second party, personal preferences of the owners of the digital promises and the second party, goals of the owners of the digital promises and the second party, and a degree of financial similarity of the owners of the digital promises and the second party. At least one of the role, the relationship status, the social distance, the number of past interactions, the previous transaction behavior, the personal preferences, the goals, and the degree of financial similarity may be determined using information retrieved from at least one social network.

Exemplary embodiments of the present invention provide a computer program product for managing digital promises. The computer program product includes a computer readable storage medium having program instructions embodied therewith. The program instructions are executable by a processor to cause the processor to perform the following steps. Receive transaction information and a request for a digital promise ranking from a first party. The transaction information includes identifying information of the first party and identifying information of a second party. Retrieve the digital promises from an electronic database. Each digital promise belongs to the first party and has a corresponding owner. Calculate a relationship score between the corresponding owner of each digital promise and the second party. The relationship score indicates a degree of relationship between the corresponding owner of each digital promise and the second party. Calculate an affinity score between the corresponding owner of each digital promise and the second party. The affinity score indicates a level of similarity between the corresponding owner of each digital promise and the second party. Calculate a reputation score of the owner of each digital promise. Calculate a final score of each digital promise based on the relationship score, the affinity score and the reputation score. Generate the digital promise ranking based on the final score of each digital promise.

### BRIEF DESCRIPTION OF THE DRAWINGS

The above and other features of the present invention will become more apparent by describing in detail exemplary embodiments thereof, with reference to the accompanying drawings, in which:

FIG. 1 is a flow chart of a method of managing digital promises according to exemplary embodiments of the present invention.

FIG. 2 illustrates an overview of exemplary informal financial practices.

FIG. 3 illustrates an example of a conventional financial scenario including customers and a factor or bank participation in a traditional factoring transaction.

FIG. 4 illustrates a balance sheet of a conventional financial scenario including customers and a factor or bank participation in a traditional factoring transaction.

FIG. 5 illustrates a financial scenario according to exemplary embodiments of the present invention.

FIG. 6 illustrates a balance sheet according to exemplary embodiments of the present invention.

FIG. 7 illustrates a workflow of a method of managing digital promises according to an exemplary embodiment of the present invention.

FIG. 8 illustrates a workflow of a method of determining an initial reputation of a digital user according to an exemplary embodiment of the present invention.

FIG. 9 illustrates a workflow of a method of updating a reputation of a user according to an exemplary embodiment of the present invention.

FIG. 10 illustrates an exemplary system for managing digital promises according to an exemplary embodiment of the present invention.

FIG. 11 illustrates an example of a computer system capable of implementing the method according to exemplary embodiments of the present invention.

### DETAILED DESCRIPTION

Exemplary embodiments of the present invention will be described more fully hereinafter with reference to the accompanying drawings. Like reference numerals may refer to like elements throughout the specification and drawings.

Exemplary embodiments of the present invention may provide a novel method and a structure to leverage informal financial transaction practices, including but not limited to payment promises, digital IOUs (e.g., a promise to pay some certain sum of money) or account receivables, which may provide a broader range of financial services to a population through a convergence of social networks and financial life. The population considered herein may include an unbanked or an underbanked population of persons (e.g., those having minimal and/or sporadic access to financial services), it should be appreciated at the outset that the teachings of this invention are applicable to other populations and groups of people (e.g., those not normally considered as being unbanked or underbanked) that engage in financially-related activities.

Exemplary embodiments of the present invention may enable users to electronically transfer payment promises to one another and build a credit network.

Exemplary embodiments of the present invention may provide a system and method to electronically trade account receivables among users in exchange for a good or a service.

Exemplary embodiments of the present invention may extend a transfer of digital IOUs from a merchant to other merchants.

Exemplary embodiments of the present invention may extend and enhance conventional peer-to-peer lending systems by providing a system and method to recommend a set of digital promise-to-pay or digital IOUs based on relationship and affinity that can be transferred among users, and establish and construct an electronic payment promise transfer network where a receiver and an owner can define a set of rules or preferences for a particular transaction.

Exemplary embodiments of the present invention may enable a user of a credit network to operate without knowing or having any personal knowledge of other users of the credit network, and provides the user the ability to define preferences and/or restrictions for transactions with those other (e.g., unknown) users.

Exemplary embodiments of the present invention may provide a system and a method to electronically transfer payment promises among system users based on a set of preferences and/or rules. The user that will receive a payment promise may define a set of conditions for the owner and sender of the payment promise.

Exemplary embodiments of the present invention may assist financial institutions by including new customers from an unbanked or underbanked population while increasing the scope of financial services for existing clients. Exemplary embodiments of the present invention may be considered to represent an alternative to unsecured micro loans.

The phrases “IOU,” “payment promise,” “promise to pay” and “digital promise” may be used interchangeably herein.

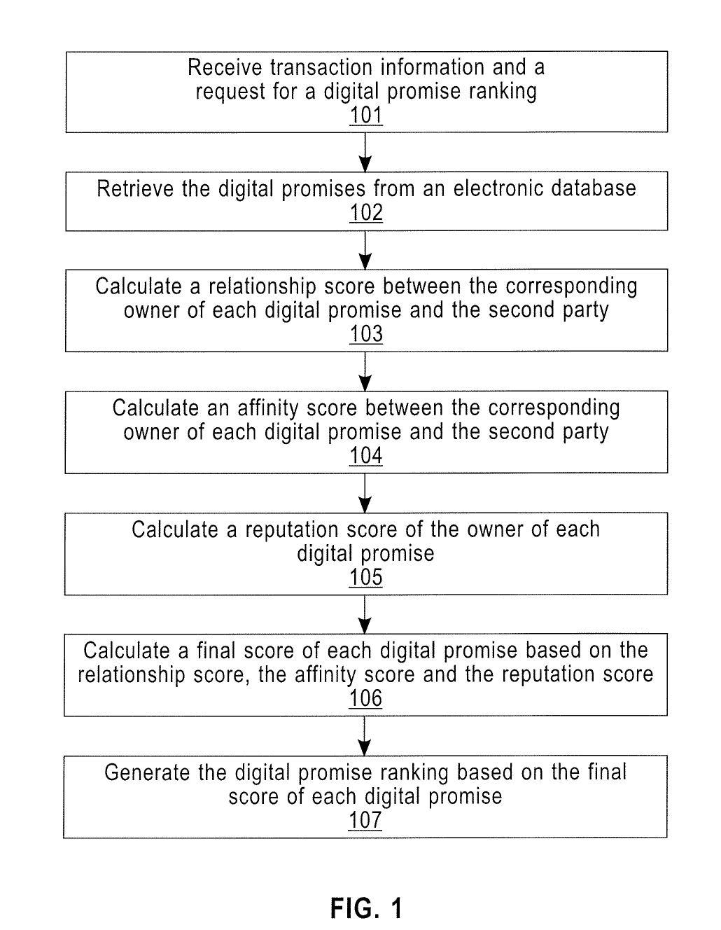

FIG. 1 is a flow chart of a method of managing digital promises according to exemplary embodiments of the present invention.

Referring to FIG. 1, a method of managing digital promises may include receiving transaction information and a request for a digital promise ranking 101. The transaction information may include identifying information of a first party and/or identifying information of a second party. The digital promises may be retrieved from an electronic database 102. Each digital promise may belong to the first party and may have a corresponding owner. A relationship score may be calculated between the corresponding owner of each digital promise and the second party 103. The relationship score may indicate a degree of relationship between the corresponding owner of each digital promise and the second party. An affinity score may be calculated between the corresponding owner of each digital promise and the second party 104. The affinity score may indicate a level of similarity between the corresponding owner of each digital promise and the second party. A reputation score may be calculated for the owner of each digital promise 105. A final score of each digital promise may be calculated based on the relationship score, the affinity score and the reputation score 106. The digital promise rank may be generated based on the final score of each digital promise 107.

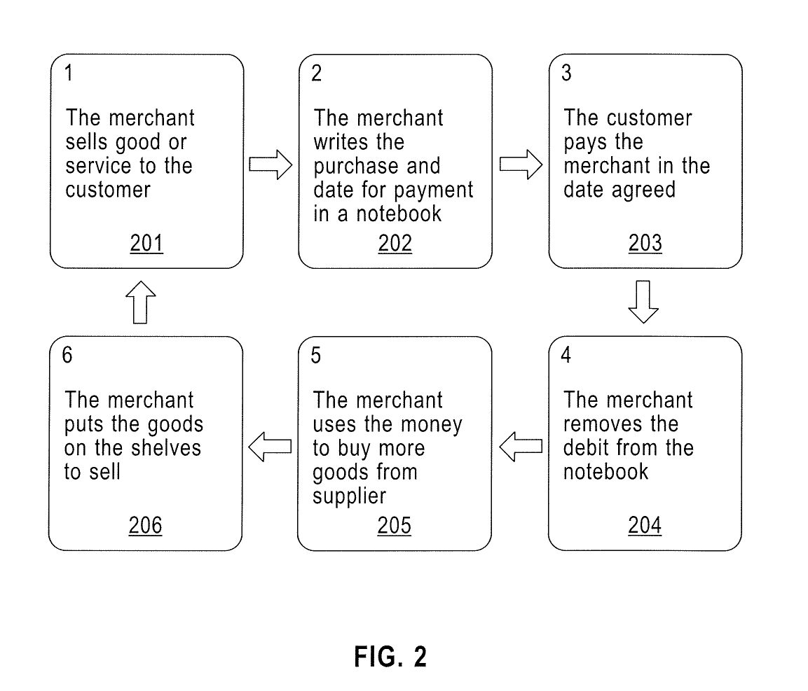

FIG. 2 illustrates an overview of exemplary informal financial practices.

Referring to FIG. 2, a merchant may sell goods and/or services to a customer 201. The merchant may write the purchase and date for payment in a notebook 202. The customer may pay the merchant on the date agreed 203 and the merchant may remove the debit from the notebook 204. The merchant may then use the money to buy more goods from a supplier 205. The merchant may place the goods on the shelves to sell 206. The informal financial practices illustrated in FIG. 2 may represent a form of credit extended to an unbanked or underbanked population. Informal financial practices according to exemplary embodiments of the present invention may provide a novel method and a structure to leverage informal financial transaction practices, including but not limited to payment promises, digital IOUs (e.g., a promise to pay a predetermined sum of money) or account receivables, in order to provide a broader range of financial services to a population through a convergence of social networks and financial life. The unbanked or an underbanked population may refer to individuals having minimal and/or sporadic access to financial services or those substantially without or with relatively limited banking and credit histories and banking transactions. However, exemplary embodiments of the present invention are not limited to this particular population of individuals.

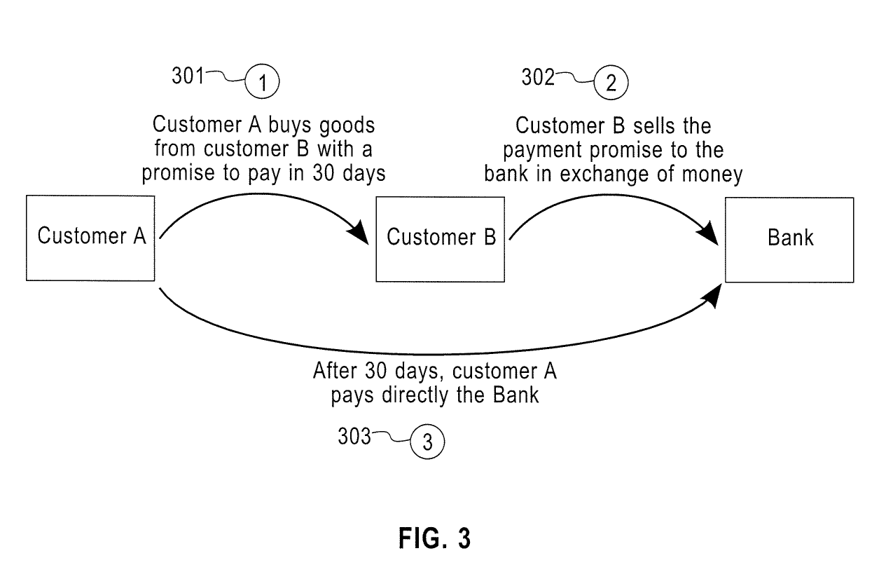

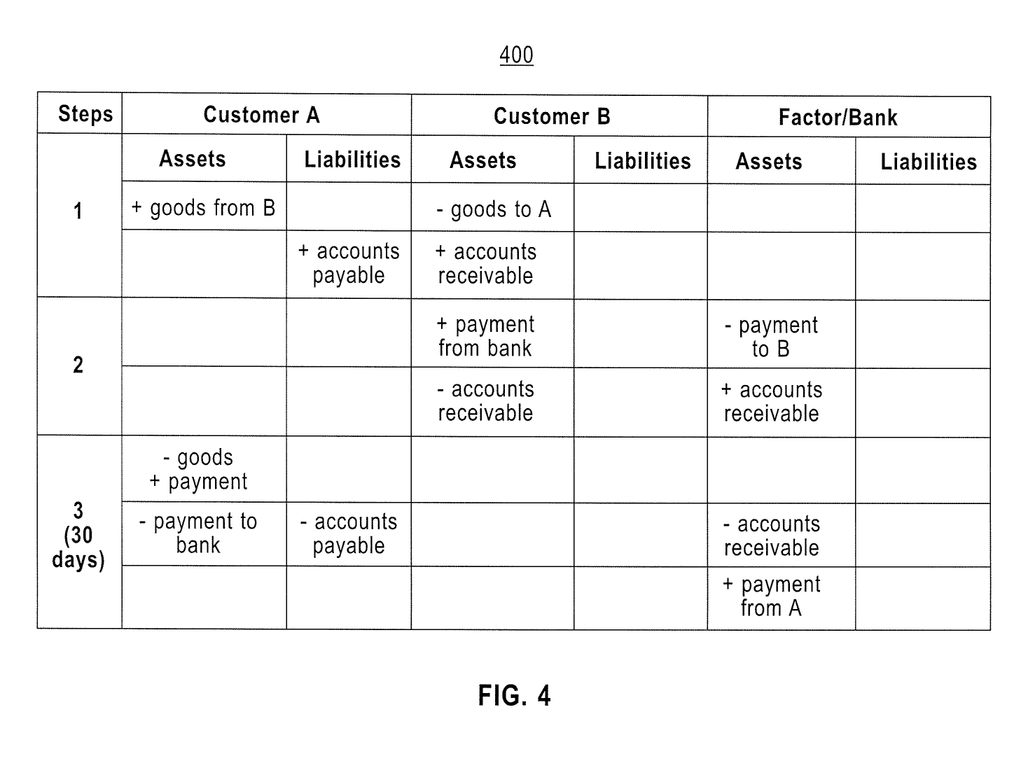

FIG. 3 illustrates an example of a conventional financial scenario including customers and a factor or bank participation in a traditional factoring transaction. FIG. 4 illustrates a balance sheet of a conventional financial scenario including customers and a factor or bank participation in a traditional factoring transaction.

Referring to FIGS. 3 and 4, a conventional financial scenario may include a debtor finance transaction or factoring where a merchant/business sells payment promises or account receivables or IOUs to a third party. Customers and a factor (e.g., a bank) may participate in a traditional factoring transaction. At step 1 customer A may buy goods from customer B on credit with a 30 day payment term (e.g., Net 30) 301. The payment promise may be represented in the balance sheet of customer A as accounts payable (liabilities side) and in the balance sheet of the customer B as accounts receivable (assets side). Customer B may sell the account receivable to a factor or a bank in exchange for cash/money. At step 2 customer B has the money and the factor or bank may be waiting for the payment directly from customer A 302. After 30 days, when customer A receives money, for example from selling goods, customer A may directly pay the factor/bank (step 3) 303.

Participating persons/merchants according to exemplary embodiments of the present invention may be referred to herein as “customers”, they can also be referred to herein interchangeably as “users” (of the system) or as “parties”.

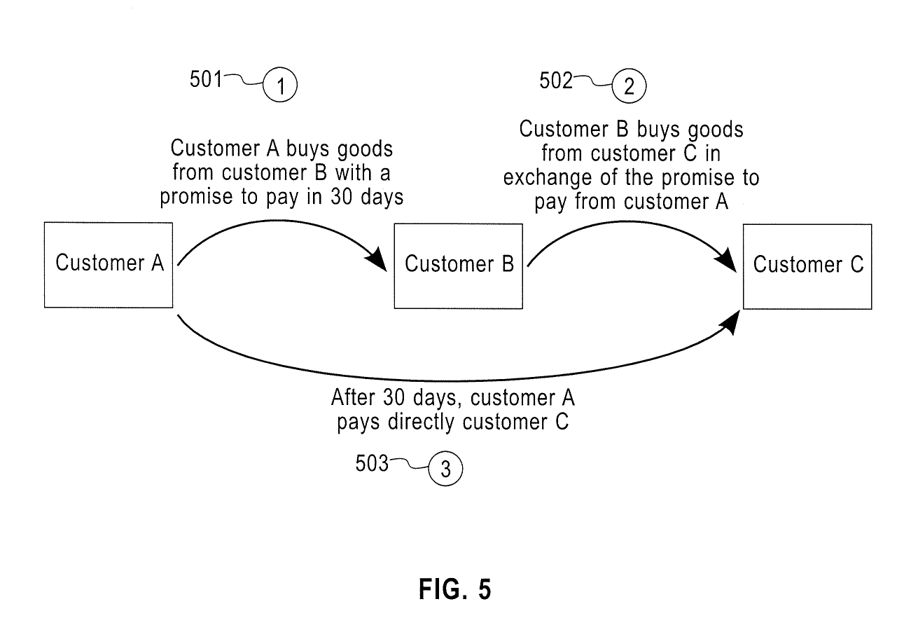

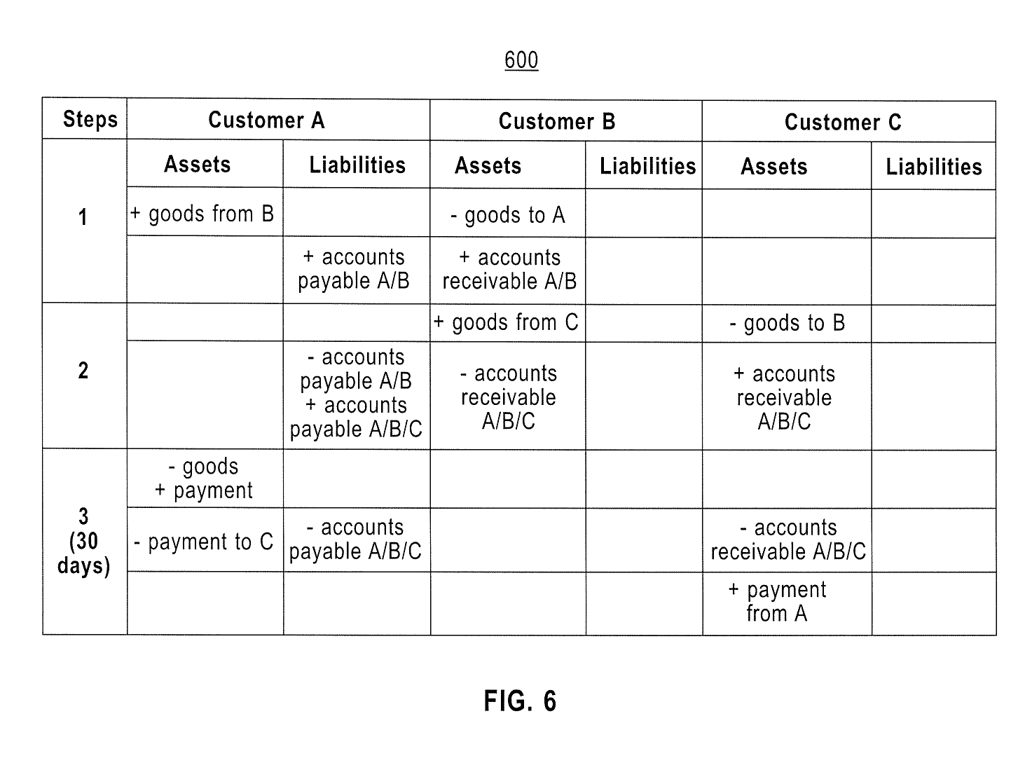

FIG. 5 illustrates a financial scenario according to exemplary embodiments of the present invention. FIG. 6 illustrates a balance sheet according to exemplary embodiments of the present invention.

Referring to FIGS. 5 and 6, customers or merchants may exchange informal payment promises or IOUs during an exchange of goods or money according to exemplary embodiments of the present invention. FIG. 6 illustrates an exemplary balance sheet in accordance with exemplary embodiments of the present invention in which the customers or merchants may exchange the promise to pay or informal account receivable in exchange for goods or money. At step 1 customer A may buy goods or services from customer B on credit with a 30 day payment term (e.g., Net 30) 501. The payment promise may be represented in the balance sheet of customer A as accounts payable A/B (liabilities side) and in the balance sheet of the customer B may appear as an accounts receivable A/B (assets side). At substantially the same time or some later time, customer B may buy goods or services from customer C (e.g., in a substantially equal amount and payment term). However, instead of creating a new account receivable for this transaction customer B may transfer (e.g., electronically transfer) to customer C the account receivable from the transaction with customer A. Thus, customer C may assume the role of a factor or bank and may give goods or money in exchange for an account receivable or a promise to pay from customer A (step 2) 502.

The payment promise transactions may involve a degree of trust among the parties exchanging the payment promise. Records of the transactions and the identity of the customers may be added in the account receivable column (e.g., account receivable A/B/C) and in the account payable from the origin column (e.g., account payable A/B/C). The system according to exemplary embodiments of the present invention may detect any attempted fraud or misbehavior of an involved customer. In step 3, after 30 days and/or when customer A receives money, for example from selling goods or services, customer A may directly pay customer C 503.

According to exemplary embodiments of the present invention, there may be different amounts and/or payment terms and the promise to pay can be split amongst different transactions.

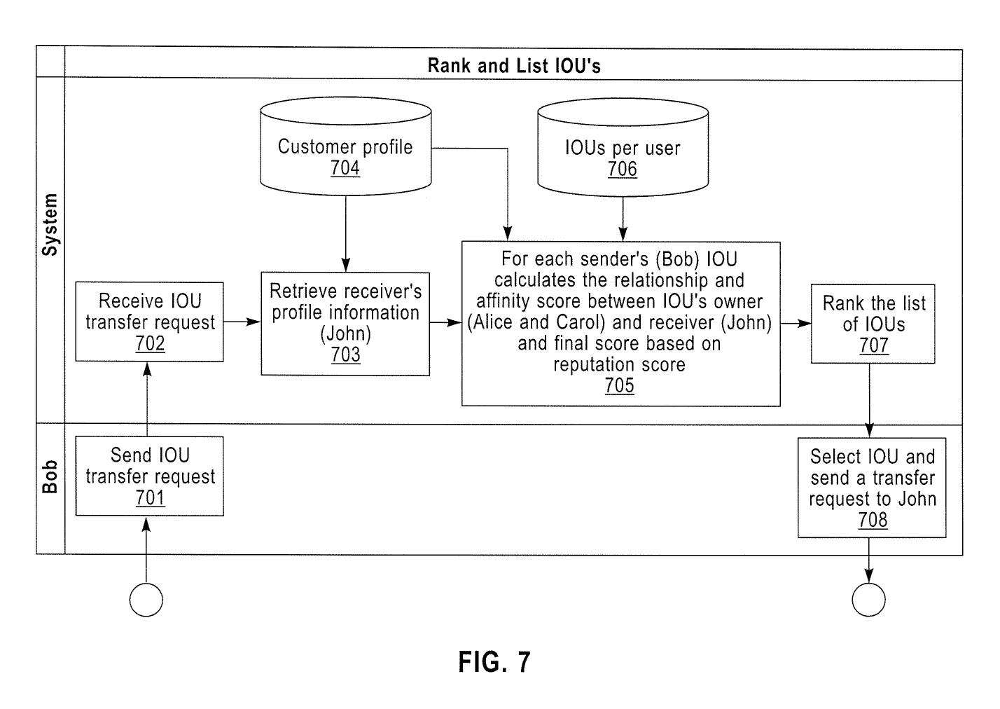

FIG. 7 illustrates a workflow of a method of managing digital promises according to an exemplary embodiment of the present invention.

Referring to FIG. 7, an IOU transfer request may be sent by a user 701 and a system according to exemplary embodiments of the present invention may receive the IOU transfer request 702. The system may receive transaction information with the IOU transfer request and the IOU transfer request may include a request for a ranking of digital promises (e.g., IOUs recorded by the system). The transaction information may include identifying information of a first party and/or identifying information of a second party. The first party may be customer B and the second party may be customer C illustrated in FIGS. 3 and 5 above. The first party may interchangeably be referred to as the sender (e.g., the sender of the digital promise) and the second party may be interchangeably referred to as the receiver (e.g., the receiver of the digital promise). In response to receiving the IOU transfer request 702, the system may retrieve the receiver's profile information 704 from a customer profile database 704. The system may retrieve customer profile information for the sender, the receiver and/or an owner of the digital promise. The owner of the digital promise is the originator of the digital promise. That is, the owner (e.g., customer A in FIG. 5 above) is the person that originally gave the digital promise.

The digital promises may be retrieved for each user (e.g., the user/sender of the digital promise) 706. The digital promises may be retrieved from an electronic database. The sender (e.g., Customer B) may hold a plurality of digital promises that may be transferred to the receiver (e.g., Customer C) and the system may rank each of the plurality of digital promises for the best match with the receiver. For example, the sender may hold a digital promise from Customer A and a plurality of other digital promises from other individuals. That is, each digital promise may belong to the first party/sender and each digital promise may have a corresponding owner/originator of the digital promise.

A relationship score may be calculated between the corresponding owner of each digital promise and the second party/receiver. The relationship score may indicate a degree of relationship between the corresponding owner of each digital promise and the second party. For example, the relationship score may be an indication of how closely connected the owner and the second party are based on a number of social connections separating the owner and the second party.

According to exemplary embodiments of the present invention, the system may calculate relationship and affinity scores between the IOU's owner and the receiver and a final score may be calculated based on reputation score, affinity score and relationship score 705, as discussed below in more detail.

An affinity score may be calculated between the corresponding owner of each digital promise and the second party. The affinity score may indicate a level of similarity between the corresponding owner of each digital promise and the second party. A reputation score may be calculated for the owner of each digital promise. A final score of each digital promise may be calculated based on the relationship score, the affinity score and the reputation score. The digital promise rank may be generated based on the final score of each digital promise. The system may rank the list of IOUs 707 and the user may then select an IOU from the list of IOU's and initiate a transfer request 708.

According to an exemplary embodiment of the present invention the relationship score may be calculated based on at least one of a role assigned to the owners of the digital promises or the second party, a relationship status between the owners of the digital promises and the second party, a social distance between the owners of the digital promises and the second party, and a number of past interactions occurring between the owners of the digital promises and the second party. The social distance between the owners of the digital promise and the second party may refer to the number of intermediary friends or social contacts separating the parties.

According to an exemplary embodiment of the present invention at least one of the role, the relationship status, the social distance, and the number of past interactions may be determined using information retrieved from at least one social network.

The system according to an exemplary embodiment of the present invention may create a relationship network that may incorporate information about each user from external sources, such as one or more social networks. The relationship network may be used in determining either initial or ongoing reputations for each user, as discussed below in more detail. For example, the relationship network may incorporate information from social networks, mobile contacts, business networks or service provider networks (e.g., housekeepers, landlords or painters), and the incorporated information may be merged to form a hybrid network that may be used by the system for determining reputation. Users of the system according to an exemplary embodiment of the present invention may have a list of contacts that participate in the system and are connected within the system described herein.

According to an exemplary embodiment of the present invention the affinity score may be calculated based on at least one of previous transaction behavior (e.g., purchasing a car, house or particular goods or services) of the owners of the digital promises and the second party, personal preferences (e.g., having a particular taste, preferring particular stores or types of travel) of the owners of the digital promises and the second party, goals (e.g., educational achievement or desires, financial savings or retirement plans) of the owners of the digital promises and the second party, and a degree of financial similarity of the owners of the digital promises and the second party.

According to an exemplary embodiment of the present invention at least one of the previous transaction behavior, the personal preferences, the goals, and the degree of financial similarity may be determined using information retrieved from at least one social network.

According to an exemplary embodiment of the present invention, information about a user used in determining the affinity score or relationship score may include personal and external financial information such as gender, age, address, education, family information, account balance information, amount in the account, past transactions (e.g., amount spent, type of store, or category of purchase), past credit history and score and pending payments history (e.g., accounts payable). Information from social networks that can enhance customer profile may include life events (e.g., marriage, child, college, job relocation, vacation) with location, date/hour, purchase pattern, purchase intention. For example, customer C may, for example, define that customer A should have the same range of age and minimum amount in the savings account.

According to an exemplary embodiment of the present invention, information about a user used in determining the affinity score or relationship score may include information about the occupation: role, company, company address, salary, education level or business activity: revenue, balance sheet or sales ledger report, credit control report, address, type of activity (e.g., retail, grocery, or service).

According to an exemplary embodiment of the present invention, information about a user used in determining the affinity score or relationship score may include information about past transactions occurring outside the system, and may include information of the amount spent or type of purchase, for example.

According to an exemplary embodiment of the present invention, information about a user used in determining the affinity score or relationship score may include information from one or more social networks, such as a user's role in the network (e.g., customer, merchant, supplier, service provider, work colleague, friend), relationship between the users, social distance (e.g., number of intermediary friends between the parties), number of connections and interactions, centrality to detect the user's influence within the social network. For example, relationship score may consider when participants are neighbors in a social network or are not directly connected but have common friends. In this case the amount of the account receivable may be higher than participants that are distant in the network. Disconnected or distantly connected participants that are relatively new to the system according to exemplary embodiments of the present invention may only exchange relatively small value IOUs. For example, if customer C is not directly connected to customer A, at the end of the transaction when customer A pays customer C, the social relationship between the parties may increase (e.g., affinity, trust, social distance) and the two customers/users may execute transactions directly after a successful transaction.

According to an exemplary embodiment of the present invention, information about a user used in determining the affinity score or relationship score may include a common interest. Information retrieved from social networks may be used to detect purchase behavior and intention (e.g., purchasing a car, house, or particular goods), preferences (e.g., taste, type of stores, or travel preferences), goals (e.g., educational attainment, savings, or retirement plans) or financial affinity. Hobbies and activities such as travelling, motorcycling or radical sports may be considered. For example, if customer A and customer B buy goods in the same category such as food or clothes. For example, if customers A, B and C participate in a community with similar interests (e.g., motorcycle riding). If customer A buys some motorcycle parts or accessories as customer C then the relationship score of affinity score may increase. The higher the financial affinity, the higher the probability may be that accounts receivable are accepted and higher amounts of accounts receivable may be accepted.

According to an exemplary embodiment of the present invention, information about a user used in determining the affinity score or relationship score may include one or more of the following universal values. Self-direction: creativity; freedom; independent thought and action-choosing; curious; choosing own goals. Stimulation: need for variety and stimulation, daring activities; varied life; exciting life. Hedonism: pleasure or sensuous gratification for oneself; enjoying life; self indulgent. Achievement: personal success demonstrating competence respecting social standards; capability; ambition; influence; intelligence; self-respect; social recognition. Power: social status and prestige; authority; leadership; dominance; ambitious; wealth. Security: safety, harmony, cleanliness; family security; national security; stability of society and relationships; reciprocation of favors; health; sense of belonging. Conformity: restraint of actions; inclinations; self-discipline; obedience; politeness; responsible. Tradition: commitment; accepting one's portion in life; humility; devoutness; respect for tradition; moderation. Benevolence: helpfulness; honesty; forgiveness; loyalty; responsibility; friendship; preserving and enhancing the welfare in group. Universalism: understanding; tolerance; broad-mindedness; protection for the welfare of all people and for nature; inner harmony.

According to exemplary embodiments of the present invention, determining the affinity score or relationship score may include detecting a set of defined characteristics, such as relationship/social network information or past transactions, using statistical models, machine learning or graph analysis to calculate a final score. Weights may be applied to the affinity score or relationship score. Weights may be applied to the affinity score or relationship score according to the importance and accuracy of the defined characteristics. Weights may be applied to the affinity score or relationship score using any the methods according to exemplary embodiments of the present invention described herein. For example, the weights may be adjusted and improved over time by means of a feedback mechanism, such as feedback provided by one or more users.

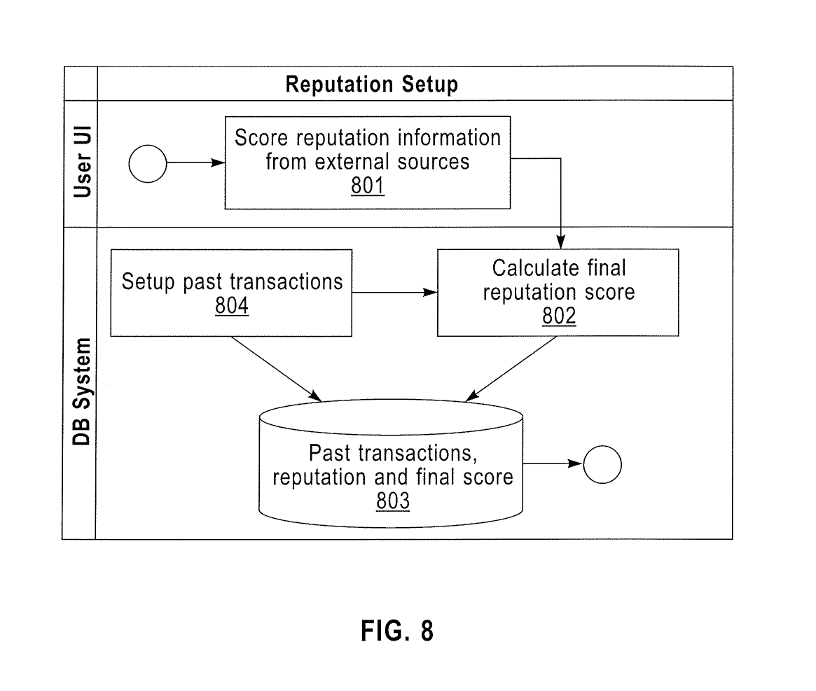

FIG. 8 illustrates a workflow of a method of determining an initial reputation of a user according to an exemplary embodiment of the present invention.

Referring to FIG. 8, an initial reputation of a user, such as a digital promise owner may be determined. The initial reputation may be an indication of the likelihood or probability that the digital promise owner will repay the IOU and/or whether the IOU will be timely paid. The owner may be a new user of the system according to exemplary embodiments of the present invention, and thus the new user may have little or no transaction history to rely on for determining an initial reputation. Thus, the system may initially rely on external sources (e.g., sources that are external to the system described herein) such as one or more social networks.

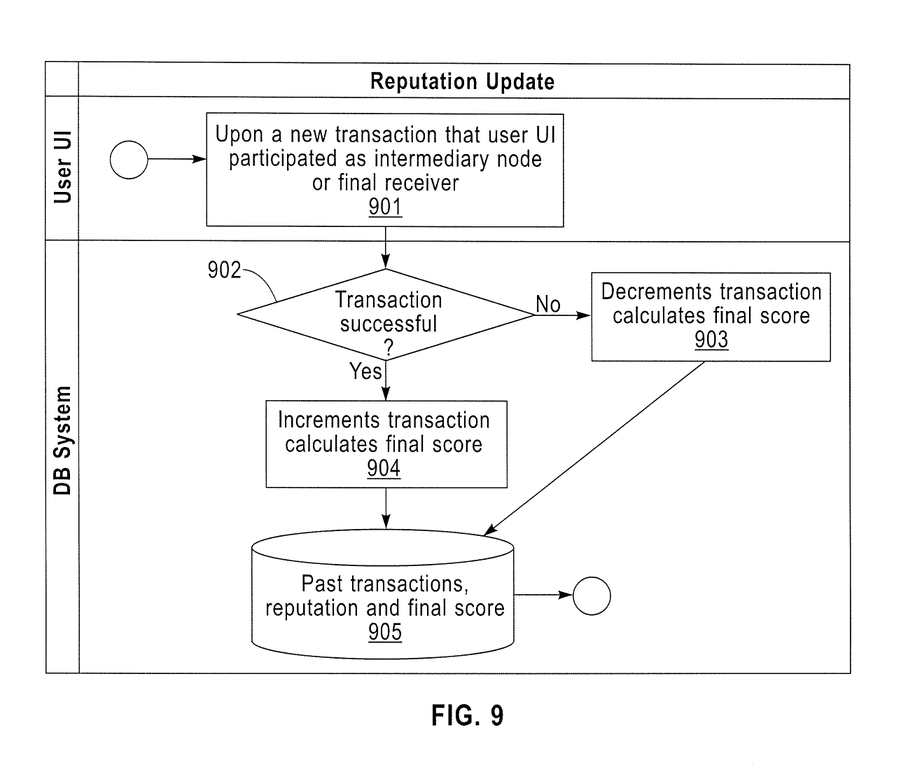

When the new user initially engages the system according to exemplary embodiments of the present invention, the system may score reputation information from external sources 801 and use that information to calculate an initial final reputation score 802. As the new user engages in transaction within the system according to exemplary embodiments of the present invention (e.g., by paying transferred IOUs) the successfully completed past transactions 804 may be combined with the initially determined final reputation score 803. As the user engages in subsequent transaction (e.g., by paying transferred IOUs), the initially determined reputation may be updated, as described below with reference to FIG. 9.

According to an exemplary embodiment of the present invention the reputation score of the corresponding owner of each digital promise may reflect the corresponding owner's reputation during a predefined time interval.

According to an exemplary embodiment of the present invention the reputation score of the corresponding owner of each digital promise may be based on the corresponding owner's average repayment time relating to repaying previous digital promises.

### Exemplary Method for Calculating Initial Reputation of a User Ui

1. Rep_ui<-Receives reputation information from external sources and applies a score
2. If Trans_ui !=0 then

2.1 Trans_ui<-last successful transactions in a predefined time interval t

### 3. Else

3.1 Trans_ui=0.

The method to calculate the initial reputation can be scheduled to be triggered in order to update the reputation information from external sources and to give priority to new transactions (period t) and remove old ones form the list. The period t can be adjusted by the sysadmin. Also, the sysadmin may configure the range of score (e.g., 0-100) based on the load of the system, i.e., number of transactions for that user in a period of time.

FIG. 9 illustrates a workflow of a method of updating a reputation of a user according to an exemplary embodiment of the present invention.

According to an exemplary embodiment of the present invention, the reputation of the user, such as the digital promise owner, may be updated upon a new transaction that the user participated in 901. The system may determine whether the transaction was successful or not 902. If the transaction is not successful it may be a decrement in calculating the final reputation score 903 and if the transaction is successful it may be an increment in calculating that final reputation score 904. That is, successful transactions in which the IOU is timely paid may increase the user's reputation score, while an unsuccessful transaction in which the IOU is not paid or the IOU is not timely paid may reduce the user's reputation score. The past transactions may be combined with the prior or initially determined reputation to calculate a new final reputation score 905. The process of updating the reputation score may be repeated each time a transaction is completed.

According to an exemplary embodiment of the present invention the reputation score of the corresponding owner of each digital promise may reflect the corresponding owner's reputation during a predefined time interval.

According to an exemplary embodiment of the present invention the reputation score of the corresponding owner of each digital promise may be based on the corresponding owner's average repayment time relating to repaying previous digital promises.

### Exemplary Method for Updating the Reputation Rep_Ui of a User Ui

1. Upon a new transaction that user ui participated as intermediary node or final receiver
2. If transaction successful, i.e., the promise payment owner paid the debt

2.1 Trans_ui<-Increments number of transactions successful

2.2 Rep_ui Rep_ui*w+(Trans_ui)*(1−w)

### 3. Else

3.1 Trans_ui<-Decrements number of transactions successful

3.2 Rep_ui<-Rep_ui*w+(Trans_ui)*(1−w).

W is a weight applied to the reputation and can be adjusted by the sysadmin. For example, the sysadmin may apply a higher weight for successful transactions and lower weight for the reputation extracted from external sources.

### Exemplary Method for Updating the Reputation Rep_Ui of a User Ui

1. Upon a new transaction that user ui participated as intermediary node or final receiver
2. If transaction successful, i.e., the promise payment owner paid the debt

2.1 Trans_ui<-Increments number of transactions successful

2.2 FRep_ui<-(Rep_ui)*(w1)+(Trans_ui)*(w2)+(AverageTimetoRepay in time t)*(w3)+(IOU received in t/Total IOU received in the system in t)(w3)+(IOU transferred in t/Total IOU Transferred in the system in t)(w4)

### 3. Else

3.1 Trans_ui<-Decrements number of transactions successful

3.2 FRep_ui<-(Rep_ui)*(w1)+(Trans_ui)*(w2)+(AverageTimetoRepay in time t)*(w3)+(IOU received in t/Total IOU received in the system in t)(w3)+(IOU transferred in t/Total IOU Transferred in the system in t)(w4).

Wi is a weight applied to the reputation and can be adjusted by the sysadmin. For example, the sysadmin may apply a higher weight for successful transactions and lower for the reputation extracted from external sources.

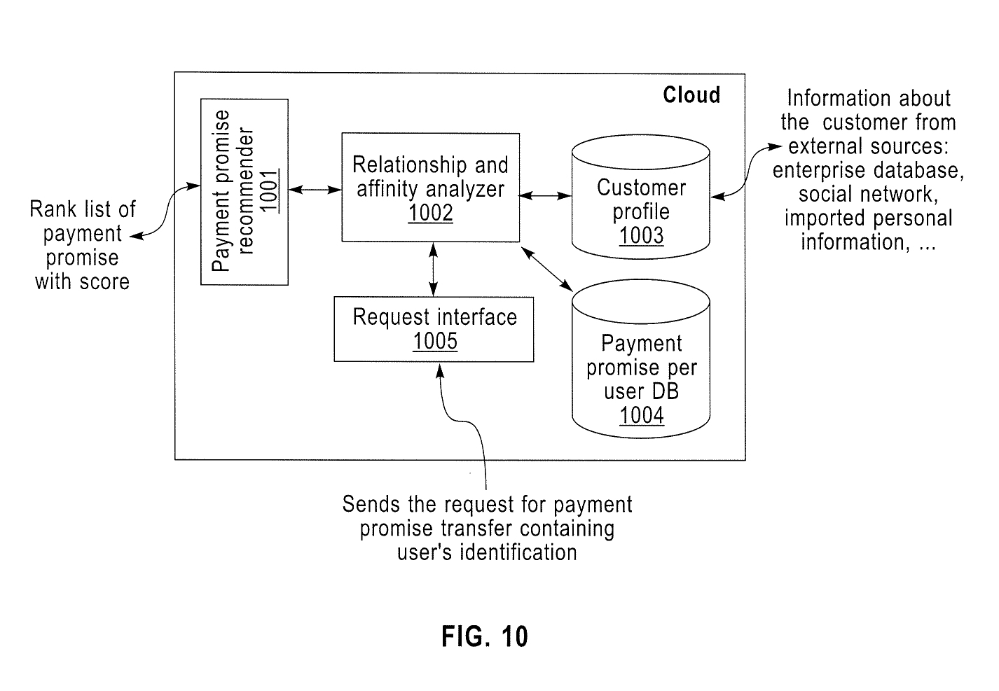

FIG. 10 illustrates an exemplary system for managing digital promises according to an exemplary embodiment of the present invention.

Referring to FIG. 10, a system for managing digital promises according to an exemplary embodiment of the present invention may include a request interface 1005, a relationship and affinity analyzer 1002, a customer profile database 1003, a payment promise database 1004 and a payment promise recommender 1001. The system for managing digital promises may operate in a cloud based server.

The request interface 1005 may receive a request for a payment promise transfer including identification of a requesting user. The requesting user may be Customer B or Customer C described above. That is, the requesting user may be the sender or the receiver of the digital promise. The request interface 1005 may communicate with the relationship and affinity analyzer 1002. The relationship and affinity analyzer 1002 may receive customer profile data for one or more users (e.g., data about owners of digital promises) and a list of payment promises from each of the one or more users. The relationship and affinity analyzer 1002 may determine the final score for each of the received payment promises. The payment promise recommender 1001 may rank the list of payment promises. The payment promises may be ranked according to the final score described above in more detail.

According to exemplary embodiments of the present invention, the customer profiles in the customer profile database 1003 may include information about each of the customers from a plurality of sources. For example, the customer information may include information from external sources, such as an enterprise database or one or more social networks, and the customer information may include imported personal and demographic information about each customer.

According to an exemplary embodiment of the present invention, when two customers B and C are negotiating a payment promise transfer, customer B may send the request to the system through the request interface 1005 with sender and receiver identification. Then, the request may be forwarded to the relationship and affinity analyzer 1002 that will retrieve all payment promises 1004 belonging to that user and the profiles of the owners 1003. The relationship and affinity analyzer 1002 may compare the profiles of the owners against the profile of the receiver and may calculate the affinity score based on the information listed above (e.g., personal and financial information, information from social network,).

According to an exemplary embodiment of the present invention a weight may be assigned to each of the relationship score, the affinity score, and the reputation score. The final score may be adjusted based on the weights. Values of the weights may be selected by one of the first party and the second party.

According to an exemplary embodiment of the present invention the system may apply the weight based on the reputation of the user for the scores and forwards to the payment promise recommender 1001. This component may then rank a list of promise payments based on the final scores of the payment promises. The ranked list may be forwarded to customer B that will select one or more to negotiate with customer C. The financial affinity between all parties (in the example customer A-customer B, customer B-customer C, customer C-customer A) may increase the likelihood of a successful transaction (e.g., all intermediary transactions and the repayment were successful).

In case of a misbehavior or fraud of an intermediary user, only this user is penalized in the system and his/her financial affinity with the other participants decreases along with other scores and may apply more restricted policies (e.g., decreases the amount, limit to certain categories).

### Exemplary Method for Recommending Payment Promises Based on Relationship and Affinity Scores

1. Upon reception payment promise transfer containing sender Sid and receiver Rid identification
2. Retrieve Pr profile information of the receiver Rid
3. For each payment promise Oi belonging to Sid

3.1. Retrieve profile information Poi of the payment promise owner

3.2. Calculate the relationship and affinity score Soi between Poi and Pr and

3.3. Calculate final score FSoi based on relationship and affinity score Soi and Rep_ui of owner (FSoi=Soi*Rep_ui)

3.4. Add in a list Li the payment promise Oi and the score FSoi

4. Rank the list Li based on the score FSoi
5. Display a ranked list Li of users.

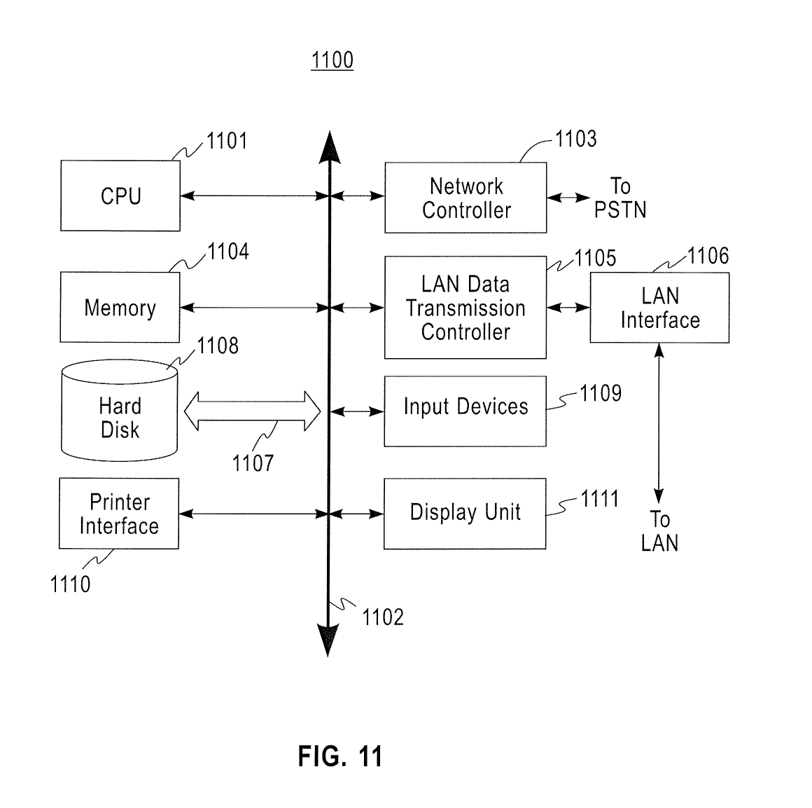

FIG. 11 illustrates an example of a computer system capable of implementing the methods according to exemplary embodiments of the present invention. The system and method of the present disclosure may be implemented in the form of a software application running on a computer system, for example, a mainframe, personal computer (PC), handheld computer, server, etc. The software application may be stored on a recording media locally accessible by the computer system and accessible via a hard wired or wireless connection to a network, for example, a local area network, or the Internet.

The computer system referred to generally as system 1100 may include, for example, a central processing unit (CPU) 1101, random access memory (RAM) 1104, a printer interface 1110, a display unit 1111, a local area network (LAN) data transmission controller 1105, a LAN interface 1106, a network controller 1103, an internal bus 1102, and one or more input devices 1109, for example, a keyboard, mouse etc. As shown, the system 1100 may be connected to a data storage device, for example, a hard disk, 1108 via a link 1107.

The descriptions of the various exemplary embodiments of the present invention have been presented for purposes of illustration, but are not intended to be exhaustive or limited to the exemplary embodiments disclosed. Many modifications and variations will be apparent to those of ordinary skill in the art without departing from the scope and spirit of the described exemplary embodiments. The terminology used herein was chosen to best explain the principles of the exemplary embodiments, or to enable others of ordinary skill in the art to understand exemplary embodiments described herein.

The flowcharts and/or block diagrams in the figures illustrate the architecture, functionality, and operation of possible implementations of systems, methods, and computer program products according to various exemplary embodiments of the inventive concept. In this regard, each block in the flowchart or block diagrams may represent a module, segment, or portion of instructions, which comprises one or more executable instructions for implementing the specified logical function(s). In alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is understood that although this disclosure relates to cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand

network access to a shared pool of configurable computing resources (e.g. networks, network
bandwidth, servers, processing, memory, storage, applications, virtual machines, and services)
that can be rapidly provisioned and released with minimal management effort or interaction with a provider of the service. This cloud model may include at least five characteristics, at least three
service models, and at least four deployment models.

Characteristics are as follows:

On-demand self-service: a cloud consumer can unilaterally provision computing capabilities, such as server time and network storage, as needed automatically without requiring

human interaction with the service's provider.

Broad network access: capabilities are available over a network and accessed through

standard mechanisms that promote use by heterogeneous thin or thick client platforms (e.g.,
mobile phones, laptops, and PDAs).

Resource pooling: the provider's computing resources are pooled to serve multiple

consumers using a multi-tenant model, with different physical and virtual resources dynamically
assigned and reassigned according to demand. There is a sense of location independence in that
the consumer generally has no control or knowledge over the exact location of the provided
resources but may be able to specify location at a higher level of abstraction (e.g., country, state,
or datacenter).

Rapid elasticity: capabilities can be rapidly and elastically provisioned, in some cases

automatically, to quickly scale out and rapidly released to quickly scale in. To the consumer, the
capabilities available for provisioning often appear to be unlimited and can be purchased in any
quantity at any time.

While the present invention has been particularly shown and described with reference to exemplary embodiments thereof, it will be understood by those of ordinary skill in the art that various changes in form and detail may be made therein without departing from the spirit and scope of the present invention as defined by the following claims.

What is claimed is:

1. A method of managing digital promises, comprising:
receiving transaction information and a request for a digital promise ranking, wherein the transaction information comprises identifying information of a first party and/or identifying information of a second party;
retrieving the digital promises from an electronic database, wherein each digital promise belongs to the first party and has a corresponding owner;
calculating a relationship score between the corresponding owner of each digital promise and the second party, wherein the relationship score indicates a degree of relationship between the corresponding owner of each digital promise and the second party;
calculating an affinity score between the corresponding owner of each digital promise and the second party, wherein the affinity score indicates a level of similarity between the corresponding owner of each digital promise and the second party;
calculating a reputation score of the owner of each digital promise;
calculating a final score of each digital promise based on the relationship score, the affinity score and the reputation score; and
generating the digital promise ranking based on the final score of each digital promise.

2. The method of claim 1, further comprising:
selecting the digital promise having the highest final score; and
electronically transferring the digital promise having the highest final score from the first party to the second party in exchange for goods or services from the second party.

3. The method of claim 1, further comprising:
outputting the digital promise ranking to a display of a user device of the first party to facilitate selection of one of the digital promises in the digital promise ranking by the first party.

4. The method of claim 1, further comprising:
receiving a set of preferences defined by at least one of the owners of the digital promises and the second party;
selecting one of the digital promises based on the digital promise ranking and the set of preferences; and
electronically transferring the selected digital promise from the first party to the second party in exchange for goods or services from the second party.

5. The method of claim 4, wherein at least one preference of the set of preferences is defined as rules comprising a Boolean expression.

6. The method of claim 1, wherein the relationship score is calculated based on at least one of a role assigned to the owners of the digital promises or the second party, a relationship status between the owners of the digital promises and the second party, a social distance between the owners of the digital promises and the second party, and a number of past interactions occurring between the owners of the digital promises and the second party.

7. The method of claim 6, wherein at least one of the role, the relationship status, the social distance, and the number of past interactions is determined using information retrieved from at least one social network.

8. The method of claim 1, wherein the affinity score is calculated based on at least one of previous transaction behavior of the owners of the digital promises and the second party, personal preferences of the owners of the digital promises and the second party, goals of the owners of the digital promises and the second party, and a degree of financial similarity of the owners of the digital promises and the second party.

9. The method of claim 8, wherein at least one of the previous transaction behavior, the personal preferences, the goals, and the degree of financial similarity is determined using information retrieved from at least one social network.

10. The method of claim 1, wherein the reputation score of the corresponding owner of each digital promise reflects the corresponding owner's reputation during a predefined time interval.

11. The method of claim 1, wherein the reputation score of the corresponding owner of each digital promise is based on the corresponding owner's average repayment time relating to repaying previous digital promises.

12. The method of claim 1, further comprising:
assigning a weight to each of the relationship score, the affinity score, and the reputation score; and
adjusting the final score based on the weights,
wherein values of the weights are selected by one of the first party and the second party.

13. A computer system configured to manage digital promises, the system comprising:
a memory storing a computer program; and
a processor configured to execute the computer program, wherein the computer program is configured to:
receive transaction information and a request for a digital promise ranking from a first party, wherein the transaction information comprises identifying information of the first party and identifying information of a second party;
retrieve the digital promises from an electronic database, wherein each digital promise belongs to the first party and has a corresponding owner;
calculate a relationship score between the corresponding owner of each digital promise and the second party, wherein the relationship score indicates a degree of relationship between the corresponding owner of each digital promise and the second party;
calculate an affinity score between the corresponding owner of each digital promise and the second party, wherein the affinity score indicates a level of similarity between the corresponding owner of each digital promise and the second party;
calculate a reputation score of the owner of each digital promise;
calculate a final score of each digital promise based on the relationship score, the affinity score and the reputation score; and
generate the digital promise ranking based on the final score of each digital promise.

14. The system of claim 12, wherein the computer program is further configured to:
select, automatically, the digital promise having the highest final score; and
electronically transfer the digital promise having the highest final score from the first party to the second party in exchange for goods or services from the second party.

15. The system of claim 12, wherein the computer program is further configured to:
output the digital promise ranking to a display of a user device of the first party to facilitate selection of one of the digital promises in the digital promise ranking by the first party.

16. The system of claim 12,
wherein the relationship score is calculated based on at least one of a role assigned to the owners of the digital promises or the second party, a relationship status between the owners of the digital promises and the second party, a social distance between the owners of the digital promises and the second party, and a number of past interactions occurring between the owners of the digital promises and the second party,
wherein the affinity score is calculated based on at least one of previous transaction behavior of the owners of the digital promises and the second party, personal preferences of the owners of the digital promises and the second party, goals of the owners of the digital promises and the second party, and a degree of financial similarity of the owners of the digital promises and the second party,
wherein at least one of the role, the relationship status, the social distance, the number of past interactions, the previous transaction behavior, the personal preferences, the goals, and the degree of financial similarity is determined using information retrieved from at least one social network.

17. A computer program product for managing digital promises, the computer program product comprising a computer readable storage medium having program instructions embodied therewith, the program instructions executable by a processor to cause the processor to:
receive transaction information and a request for a digital promise ranking from a first party, wherein the transaction information comprises identifying information of the first party and identifying information of a second party;
retrieve the digital promises from an electronic database, wherein each digital promise belongs to the first party and has a corresponding owner;
calculate a relationship score between the corresponding owner of each digital promise and the second party, wherein the relationship score indicates a degree of relationship between the corresponding owner of each digital promise and the second party;
calculate an affinity score between the corresponding owner of each digital promise and the second party, wherein the affinity score indicates a level of similarity between the corresponding owner of each digital promise and the second party;
calculate a reputation score of the owner of each digital promise;
calculate a final score of each digital promise based on the relationship score, the affinity score and the reputation score; and
generate the digital promise ranking based on the final score of each digital promise.

18. The computer program product of claim 17, wherein the program instructions executable by the processor cause the processor to:
select, automatically, the digital promise having the highest final score; and
electronically transfer the digital promise having the highest final score from the first party to the second party in exchange for goods or services from the second party.

19. The computer program product of claim 17, wherein the program instructions executable by the processor cause the processor to:
output the digital promise ranking to a display of a user device of the first party to facilitate selection of one of the digital promises in the digital promise ranking by the first party.

20. The computer program product of claim 17,
wherein the relationship score is calculated based on at least one of a role assigned to the owners of the digital promises or the second party, a relationship status between the owners of the digital promises and the second party, a social distance between the owners of the digital promises and the second party, and a number of past interactions occurring between the owners of the digital promises and the second party,
wherein the affinity score is calculated based on at least one of previous transaction behavior of the owners of the digital promises and the second party, personal preferences of the owners of the digital promises and the second party, goals of the owners of the digital promises and the second party, and a degree of financial similarity of the owners of the digital promises and the second party,
wherein at least one of the role, the relationship status, the social distance, the number of past interactions, the previous transaction behavior, the personal preferences, the goals, and the degree of financial similarity is determined using information retrieved from at least one social network.
